(19) United States
(12) Patent Application Publication
(10) Pub. No.: US 2008/0072721 A1
(43) Pub. Date: Mar. 27, 2008

(54) WIRE CUTTING MACHINE AND METHOD OF CUTTING WIRE SEGMENTS FROM AN ADVANCING STRAND OF WIRE

(75) Inventor: Michael Kern, South Beloit, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Rockford Manufacturing Group Inc., South Beloit, IL (US)

(21) Appl. No.: 11/860,920

(22) Filed: Sep. 25, 2007

Related U.S. Application Data
(60) Provisional application No. 60/847,004, filed on Sep. 25, 2006.

(51) Int. Cl. B26D 5/28

(52) U.S. Cl. 83/37; 83/76

(57) ABSTRACT

A method and apparatus for cutting segments of wire from an advancing wire strand is disclosed. The segments can have a selectively predetermined length, and are cut from a strand traveling into a machine at a feed speed. The machine includes a moveable cutter that accelerates to the feed speed of the strand in a direction along the strand. A length of strand extending past the cutter is determined at real time based on a signal from a proximity sensor. When the speed of the cutter closely matches the feed speed and when the length of the strand extending past the cutter is determined to be equal to the predetermined length, the cutter is commanded to cut the strand and return to a home position.

### CROSS-REFERENCE TO RELATED APPLICATIONS

This patent application claims the benefit of U.S. Provisional Patent Application Ser. No. 60/847,004, filed Sep. 25, 2006, which is incorporated by reference.

### BACKGROUND

Apparatus for cutting segments of wire from a continual wire feed are known. A typical wire cutting apparatus includes a supply of wire stock pulled into a processing and cutting arrangement. Various examples of known wire cutting apparatus can be found in the following U.S. Patents, which are incorporated by reference: (1) U.S. Pat. No. 5,850,773 titled “Apparatus For Cutting Wire,” granted on Dec. 22, 1998 to Irvin Burns; (2) U.S. Pat. No. 5,921,160 titled “Release Assembly For A Wire Cutting Apparatus,” granted on Jul. 13, 1999 to Michael Yankaitis et al.; (3) U.S. Pat. No. 6,508,152 titled “Clutchless Wire Cutting Apparatus,” granted on Jan. 21, 2003 to Michael Kern et al.; and (4) U.S. Pat. No. 6,708,591 titled “Clutchless Wire Cutting Apparatus,” granted on Mar. 23, 2004 to Michael Kern et al.

As can be appreciated, it is desired to operate a wire cutting apparatus with speed and accuracy. Even though there have been attempts in the past to increase the speed and/or accuracy of the wire cutting apparatus, these two parameters of operation are, to a certain extent, mutually exclusive. Hence, accuracy in the length of wire cut by the apparatus per stroke can be attained, but at a slower speed. Conversely, higher speeds of operation also decrease the accuracy of the cuts performed to the wire.

### BRIEF SUMMARY OF THE INVENTION

The invention provides a method and related apparatus for cutting segments of wire from an advancing wire strand. The segments can have a selectively predetermined length and be cut from a strand entering a machine at a feed speed. The machine includes a moveable cutter intermittently accelerated to the feed speed of the strand in a direction along the strand. A length of strand extending past the cutter is determined at real time based on a signal from a proximity sensor. When the speed of the cutter closely matches the feed speed and when the length of the strand extending past the cutter is determined to be about equal to the predetermined length, the cutter is commanded to cut the strand and return to a home position.

In one aspect, the disclosure provides a method for selectively cutting segments of wire from an advancing strand of wire stock material, with the strand advancing continuously into a wire cutting machine at a constant speed. The leading edge of the strand passes through a shearing assembly, which is movable in the direction of the advancing strand. A shuttle directly or indirectly makes contact with the leading edge and is pushed along at the strand speed. The shuttle defines a first feature and a second feature thereon. Proximity of the first feature is sensed with a first sensor and a signal is relayed to an electronic controller. The first signal triggers acceleration of the shearing assembly to the strand speed. At the same time, proximity of the second feature is sensed with a second sensor yielding a second signal relayed to the controller. The second signal is indicative of the length of the advancing strand extending past the shearing assembly and also indicative of the strand speed. The strand is cut with the shearing assembly when the shearing assembly is traveling at the strand speed and when the length of the advancing strand extending past the shearing assembly is within a predetermined range.

### BRIEF DESCRIPTION OF THE SEVERAL VIEWS OF THE DRAWINGS

FIG. 1 is a top view of a wire cutting machine in accordance with the disclosure.

FIG. 2 is a front view of the wire cutting machine shown in FIG. 1.

FIG. 3 is a top view of a release assembly in accordance with the disclosure.

FIG. 4 is a cross section of the release assembly shown in FIG. 3.

FIG. 5 is a block diagram of various “snapshots” taken during a cutting cycle, shown as five successive illustrations, in accordance with the disclosure.

FIG. 6 is a block diagram for a wire cutting machine in accordance with the disclosure.

FIG. 7 is a flowchart for a method of cutting wire segments from an advancing strand of wire in accordance with the disclosure.

### DETAILED DESCRIPTION

The present disclosure provides an apparatus of and method for cutting wire segments of predetermined lengths from an advancing strand of wire. The embodiments described herein draw on illustrative examples of structures useable to cut the wire segments, but these structures should not be construed as limiting. The wire cutting machine described herein is advantageously capable of achieving high cycle rates for wire cutting operations, is fully adjustable to accommodate wires of various lengths, is fully automated to provide ease of use with minimal hardware adjustments when changing from one cutting configuration to another, and provides wire segments cut accurately at high rates.

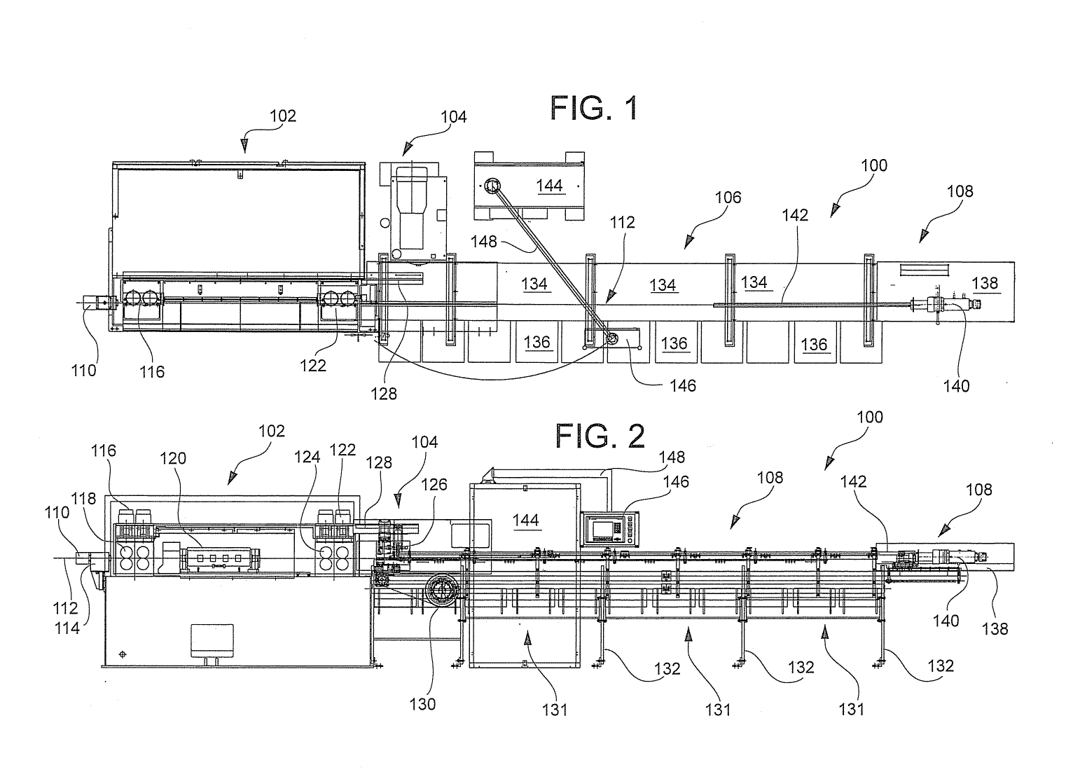

An outline view of a cutting machine 100 is shown from a top perspective in FIG. 1 and from a front perspective in FIG. 2. The cutting machine 100 includes a feed portion 102, a cutting or shearing portion 104, a frame portion 106, and a return assembly portion 108. Alternative configurations for the cutting machine 100 may include fewer portions depending on the operations being performed. For example, a manufacturing environment having an advancing strand of wire having just been formed may omit the feed portion 102. Further, if the wire segments being cut are relatively short, the frame portion 106 may be omitted, and so forth.

The feed portion 102 includes a guide 110 receiving an advancing strand 112 of wire, for example, steel wire from an unwinding coil (not shown). The advancing strand 112 may be lubricated by a lubricator 114 before being pushed into the machine by a first feed header 116 having a plurality of opposed rollers 118 operating to push the strand 112. A rotating arbor 120 may straighten the strand 112, which may then continue through a second feed header 122. The second feed header 122 also includes a plurality of opposed rollers 124 operating to pull the strand 112.

The advancing strand 112 then enters the shearing portion 104, which includes a traversing or “flying” shear assembly 126. The shear assembly 126 is moveable along a rail 128. Motion of the shear assembly 126 is accomplished by an appropriately configured motor 130. The motor 130 in this embodiment is an electric motor having a position encoder (not shown) integrated therewith capable of encoding and transmitting the position of the motor 130 instantaneously during operation. The motor 130 may be any type of electric motor known, for example, a servo motor, stepper motor, and so forth, and the encoder may be any type of axial or angular position sensor capable of relaying information about the operation of the motor 130 to an electronic controller. In an alternate embodiment, the motor 130 may be replaced by a linear actuator arranged to move the shear assembly 126 axially along the rail 128.

The frame portion 106 can advantageously have an adjustable size and includes, in the embodiment shown, three modular stands 131. Each modular stand 131 includes a set of legs 132 connected to a segment of a working structure 134 hopper 136. More or fewer modular stands 131 may be connected to the shearing portion 104 of the machine 100 depending on the length of wire being cut. For example, more modular stands 131 can be added to the machine 100 adjacent to the working structure 134 to accommodate larger segments of cut wire being cut and stored in the hopper 136. Conversely, fewer than three or even no modular stands 131 may be used when the machine 100 operates to cut smaller segments of wire.

The return assembly 108 includes a shelf 138 connected to the last modular stand 131. The shelf 138 supports a release assembly 140 housing at least a portion of a gage bar 142. The gage bar 142 extends at least partially over a portion of the working structure 134 and intermittently contacts a leading edge of the strand 112 during operation of the machine 100. After a segment of the strand 112 has been cut to a predetermined length by the shearing portion 104, a leading or cut end of the strand 112 continues to advance until it meets a nose 143 of the gage bar 142. Following contact between the leading edge of the strand 112 and the nose 143, the advancing motion of the strand acts to push the gage bar 142 deeper into the release assembly 140. The function of the release assembly 140 is described in further detail below.

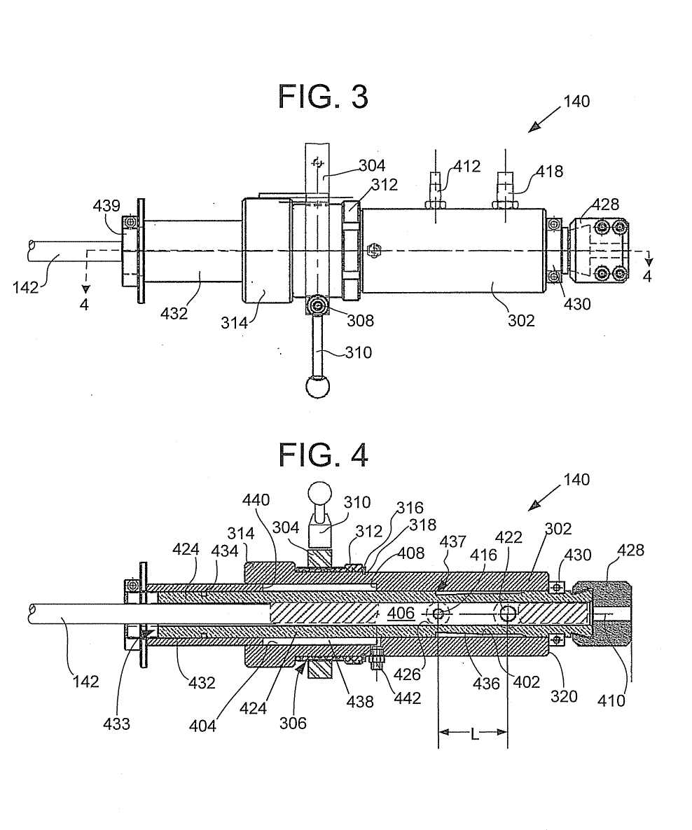

An electronic controller 144 is operably connected to various components of the machine 100 and operates to receive information from various sensors as well as send command signals for actuation of various actuators or motors of the machine 100. Moreover, the controller 144 is connected to position sensors (described relative to FIG. 3 below) associated with the release assembly 140 that relay information to the controller 144 about the position and speed of the leading edge of the strand 112. Notably, the controller 144 is operably connected to a user interface panel 146 located on the distal end of a pivoting arm 148. The panel 146 may be used by an operator to both retrieve and input information to the controller 144 and achieve a desired operating mode of the machine 100. The arm 148 advantageously facilitates ease of access to the panel 146 by an operator.

An outline view of the release assembly 140 is shown in FIG. 3 with a section view thereof along line 4-4 shown in FIG. 4. The release assembly 140 includes a housing 302 rigidly connected to a support member 304. The support member 304 is operably connected to the shelf 138 of the return portion 108 and can operate to clamp the release assembly 140. The release assembly 140 is located within a clamp opening 306 secured with a fastener 308 connected to a handle 310. When adjustments to the position of the release assembly 140 with respect to the machine 100 are desired, the operator may simply loosen the fastener 308 using the handle 310 and adjust the axial position of the release assembly 140. The housing 302 is connected to the support member 304 with an adjustment collar 312. The adjustment collar 312 advantageously enables fine adjustments to the position of the release assembly 140 even when the machine 100 is in operation. The adjustment collar 312 is constrained against axial motion with respect to the housing 302 by a shoulder portion 314 formed externally to the housing 302 and with a lock ring 316 positioned within a circumferential channel 318 formed external to the housing 302.

A stepped bore 402 is defined within the housing 302. The stepped bore 402 extends through the housing 302 and includes a return portion 404 and a guide portion 406. The two portions meet at a stop 408 formed internal to the housing 302 and extending radially inward toward a centerline 410 of the stepped bore 402. A first sensor or switch 412 is mounted to the housing 302. The first sensor 412 is a proximity sensor arranged to sense the proximity of objects within the guide portion 406 of the stepped bore 402, at real time. The first sensor 412 communicates with the guide portion 406 of the bore 402 through a first opening 416 defined in the housing 302 and extending radially into the housing 302 perpendicularly to the centerline 410. In a similar fashion, a second sensor 418 is mounted to the housing 302. The second sensor 418 is a proximity sensor arranged to sense the proximity of objects within the guide portion 406. The second sensor 418 communicates with the guide portion 406 through a second opening 422 defined in the housing 302 and extending radially into the housing 302 perpendicularly to the centerline 410. A distance, L, along the centerline 410 separates the first opening 416 and the second opening 422.

A shuttle rod 424 is located within the stepped bore 402 of the housing 302. The shuttle rod 424 is arranged to fit slideably within the bore 402 and is capable of reciprocal motion. The shuttle rod 424 forms an internal bore 426 extending through the shuttle rod 424. On one end, the shuttle is connected to a stop block 428 blocking at least a portion of the opening of the internal bore 426. The stop block 428 rigidly connects the gage rod 142 and the shuttle rod 424 such that the two components can reciprocate in unison within the stepped bore 402 of the housing 302.

A clamp 430 is connected around a portion of the shuttle rod 424 to limit its travel with respect to the housing 302. When the shuttle rod 424 is in a retracted position, the clamp 430 abuts a distal end surface 320 of the housing 302. A hollow plunger 432 is located around a distal end of the shuffle rod 424, opposite the stop block 428, and close to an open end 433 of the rod. The plunger 432 is arranged to fit within the return portion 404 of the stepped bore 402 of the housing 302 and is rigidly connected to the shuttle rod 424 in a telescopic fashion. A seal 434 fluidly blocks the interface between the shuttle rod 424 and the plunger 432. The shuttle rod 424 has a smooth outer shape over portions adjacent to each distal end, and a tapered portion 436 separating the smooth portions. When the shuttle rod 424 is in the retracted position within the housing 302, the tapered portion 436 is arranged to be adjacent to the first and second sensor openings 416 and 422.

In the exemplary embodiment presented, the tapered portion 436 tapers in a radially inward direction toward the centerline 410, with the tapering gradually increasing in depth along a direction from the second sensor opening 422 toward the first sensor opening 416 up to a step 437 along the centerline 410. As can be appreciated, the tapered portion 436 may extend further than what is shown in the cross section of FIG. 4 or may alternatively be arranged to taper in the opposite direction. Moreover, even though the taper extends entirely around the shuffle rod 424, it can alternatively be formed such that only a portion of the outer profile of the shuttle rod is tapered. The gage rod 142 extends through the internal bore 426 of the shuttle rod 424, passing through the open end 433, and abutting the stop block 428. The gage rod 142 extends past the open end 433 of the shuttle rod 424 by an appropriate extent depending on the desired length of wire to be cut. The gage rod 142 is rigidly connected to both the plunger 432 as well as the shuttle rod 424. A stop collar 439 acts to limit motion of the gage rod 142 with respect to the housing 302.

During operation of the machine 100, an advancing wire initially touches and then pushes the gage rod 142 toward the release assembly 140. The pushing motion of the gage rod 142 causes the shuttle rod 424 and plunger 432 to move from the retracted position to an extended position. During motion, the clamp 430 is moving away from the distal end surface 320. As the shuttle rod 424 moves, the plunger 432 enters a piston volume 438 defined within the return portion 404 of the stepped bore 402 between the stop 408 and an inner annular face 440 of the plunger 432. In this embodiment, the piston volume 438 may be filled with a fluid, instead of a spring, communicated to the piston volume 438 via a fitting 442 connected to a source of pressurized fluid (not shown). In this configuration, an operator may adjust the return force pushing the shuttle rod 424 back to the retracted position as well as finely control of the force resisting the advancing strand. In an alternate embodiment, the piston volume 438 may contain a resilient element, for example, a spring, disposed to compress by the motion of the plunger 432 to aid the shuttle rod 424 return to the retracted position after the wire segment had been cut.

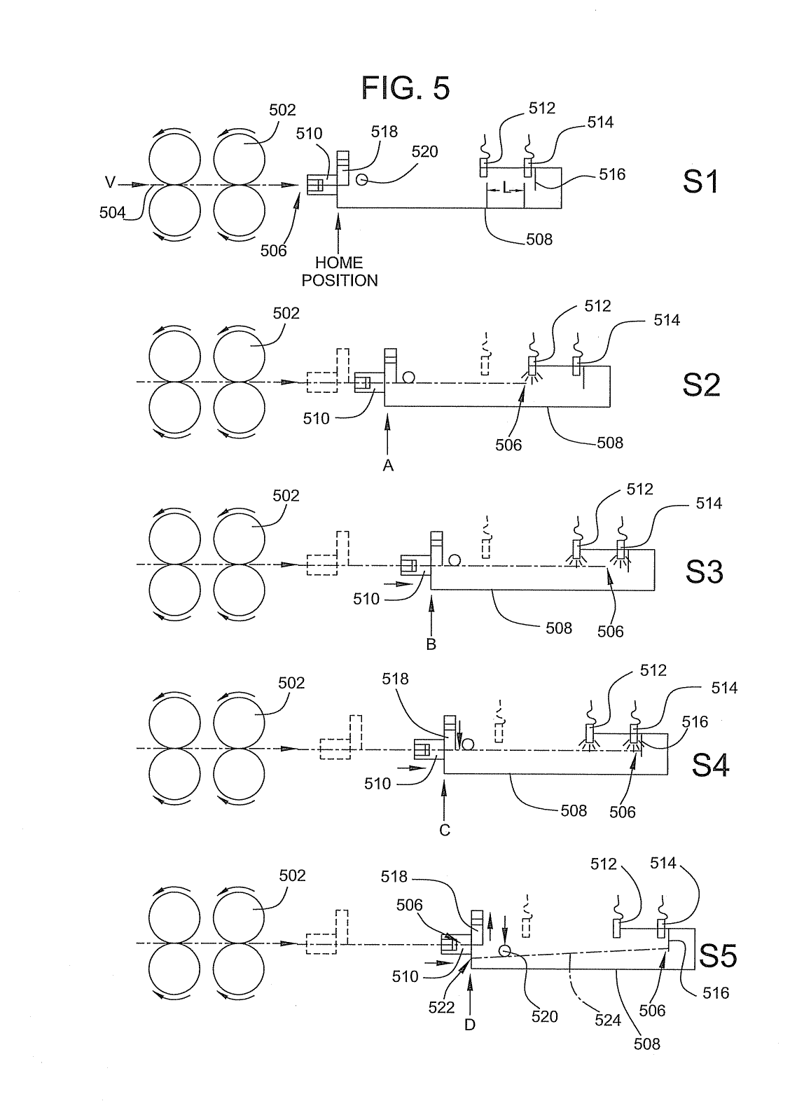

A block diagram of various “snapshots” taken during a cutting cycle are shown in the five successive illustrations of FIG. 5. During operation of the wire cutting machine 100, the feed portion, shown generally as a set of rollers 502, supplies a strand 504 of wire stock material to the machine at a speed or feed rate, V, which for the sake of simplicity is considered constant even though, as can be appreciated, minor variations thereof are normally to be expected. During a first segment of operation, represented by the first illustration, S1, the leading edge 506 of the strand 504 advances toward the shearing and release portions, shown generally connected to each other and denoted as 508.

During a second segment of operation, S2, the leading edge 506 has advanced past a shear guide 510 and is proceeding toward a first proximity sensor or switch 512. The sensor 512 senses the presence of the leading edge 506 in its vicinity and may send a first signal to an electronic controller operably connected thereto, as described above. This first signal can serve as the initiation signal for the operation and may signify motion initiation of the shuttle rod due to contact of the leading edge with the gage rod. Having received the first signal, the electronic controller may send a command to a motor (described above but not shown here), connected to the shear guide 510, to begin accelerating the shear guide 510 in a direction following the leading edge 506. At the instant represented in S2, the shear guide has already advanced to a position, A, past the “home position” shown in S1.

At a third instant, S3, the leading edge 506 has continued to progress into the cutter 508 and the motor, under the command of the electronic controller, has continued accelerating the shear guide 510. During this segment, an encoder or other position sensor associated with the motor has been sending information back to the controller about the position of the shear guide over time. The controller can use this information to calculate the speed of the shear guide and command the motor to perform adjustments to the acceleration of the shear guide such that the speed of the shear guide is made to match the speed V of the strand 504 as closely as possible. In the instant S3, the shear guide 510 has attained the desired speed and is traveling at the speed, V, which is the same speed as the strand 504. At this instant, the shear guide 510 has progressed to a new position, B.

While the shear guide 510 is moving at the speed V of the strand 504, the second position sensor 514 is measuring the distance of the approaching leading edge 506. The electronic controller receiving a second position signal from the second position sensor is able to directly calculate the speed of the approaching leading edge 506, which is also the speed of the strand 504, and perform adjustments, if necessary, to the speed command to the motor moving the shear guide 510. Moreover, the controller can also deduce the position of the leading edge 506 with respect to a virtual or actual stop 516.

In the time between the third instant S3 and a fourth instant S4, the controller is waiting for two conditions to be met simultaneously. The first condition is an indication of the speed of the shear guide 510 matching the speed of the strand. The second condition is an indication from the second position sensor 514 of the leading edge 506 reaching the stop 516. At the instant S4, the first condition and the second condition have been met and the controller is ready to issue a command to a shearing plate 518 to cut the strand 504. The controller may command an actuator (not shown here but described above) to move the shearing plate 518 relative to the shear guide 510 such that the strand 504 is “pinched” and shears, with the shear guide 510 being at a position, C. The length between the position C and the stop 516 represents a desired length for segments of wire to be cut by the machine during each operation.

Immediately following the cut operation described in S4, an optional wiper pin 520 may descend in response to a command from the controller to push a freshly cut end 522 of the strand 504 away from the shear guide 510, at instant, S5, and push the cut segment of wire 524 away and into a hopper (not shown here) before the machine resets to prepare for the next cutting operation. Following segment S5, the controller acts to raise the shearing plate 518, return the shear guide 510 from a fully extended position, D, back to the home position, and raise the wiper pin 520 so the machine can reset and prepare to repeat the entire process.

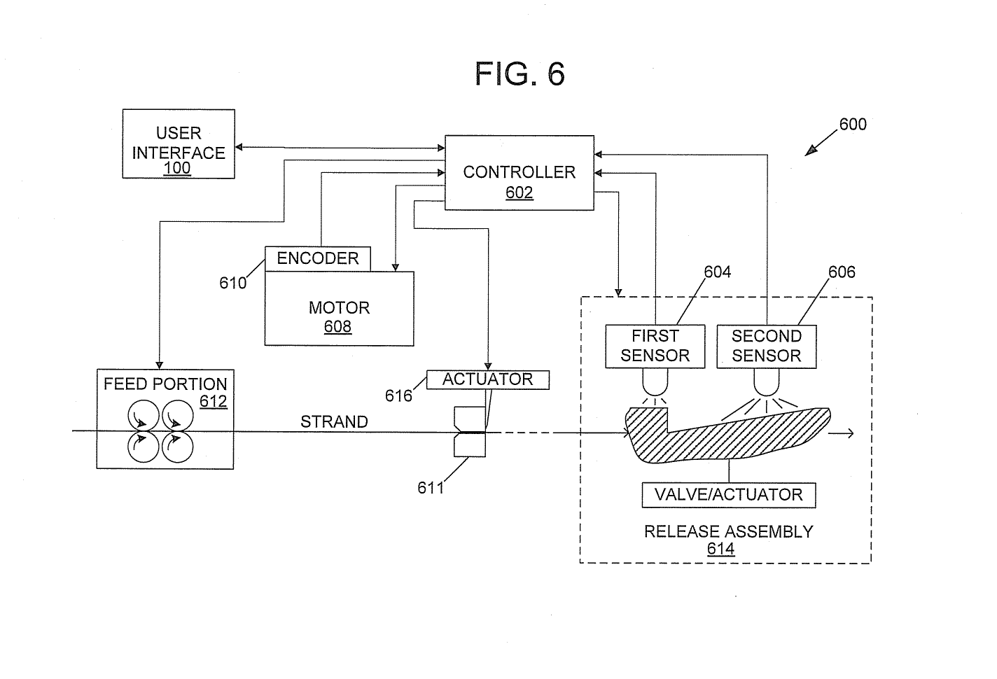

A block diagram of a wire cutting machine 600 in accordance with the disclosure is shown in FIG. 6. The machine 600 includes an electronic controller 602 connected to a first and second proximity sensors 604 and 606 via appropriate communication lines. The first and second proximity sensors 604 and 606 may be any type of sensor capable of sensing a position or proximity of an object at real time. In this embodiment, the first proximity sensor 604 may be a proximity switch adapted to send a signal to the controller 602 indicating the presence of a feature passing by the sensor, for example, the step 437 defined on the shuttle rod 424 shown in FIG. 4 as it passes in front of the first sensor opening 416 when the leading edge of the strand begins pushing on the gage rod 142. The second sensor 606 may be an analog proximity sensor adapted to relay a relative position of an object back to the controller 602, for example, the relative position of the shuttle rod 424 as it passes in front of the second opening 422, interpreted by a reading of the distance between the second sensor 418 and a location on the tapered portion 436 defined on the shuttle rod 424.

The controller 602 is also connected to a motor 608 having an encoder 610 integrated therewith. The motor 608 may be arranged to move a traversing shear arrangement 611 along a rail, for example, the traversing shear assembly 126. The encoder 610 may be an analog position sensor or an appropriate digital device capable of relaying to the controller 602 an appropriate analog or digital signal indicative of the position of the motor 608 and, therefore, the position of the traversing shear arrangement 611. The controller 602 may also be connected to various other components and systems of the machine 600. For example, the controller 602 may control the operation of motors or actuators within the strand advancing feed portion 612, actuators or valves controlling a return motion of a release assembly 614, and/or an actuator actuating a cutter 616, and may even be connected to an input/output interface device 618 used by an operator to program the controller 602 and/or operate the machine 600. The components and systems presented herein are for illustration of the exemplary embodiment described and should not be construed as exclusive or limiting. Other systems and/or actuators exchanging additional information and commands with the controller 602 may be connected to the controller 602.

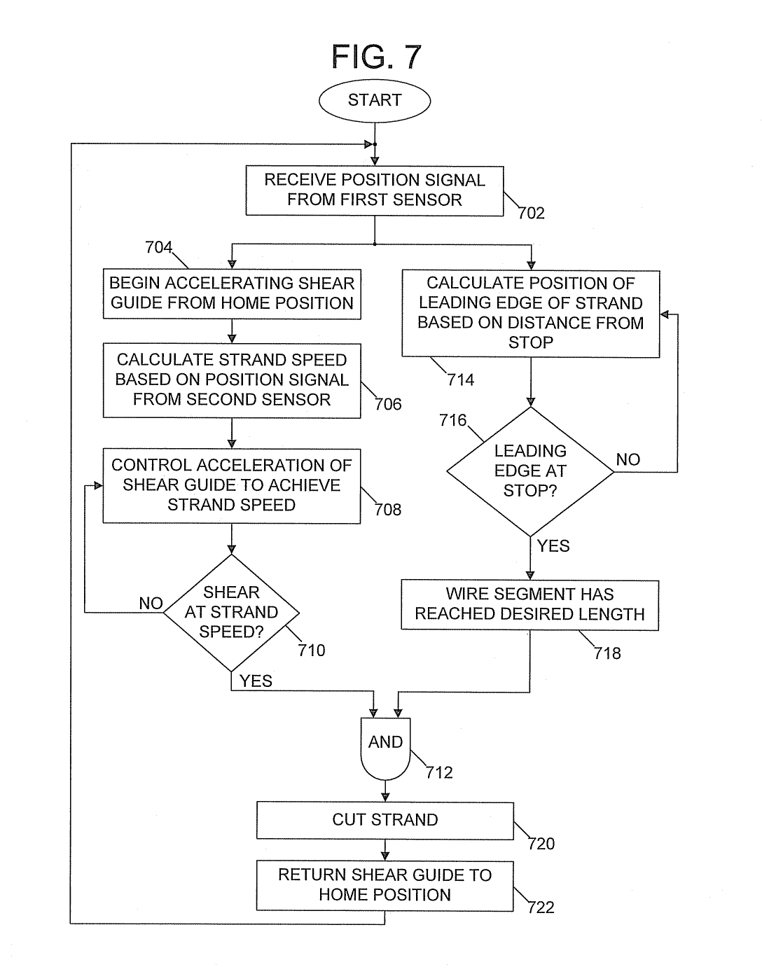

A flowchart for a method of operating a wire cutting machine is shown in FIG. 7. The electronic controller initiates a cutting process upon receipt of a position signal from the first position sensor at 702. The signal from the first position sensor indicates the commencement of motion of the return assembly by action of the leading edge of the strand contacting the nose of the gage rod. The cutting process then performs two sub-processes in parallel. The first sub-process deals with acceleration of the shear guide to the speed of the strand. Upon receipt of the first signal, the controller commands the motor to begin accelerating the shear guide at 704. The strand speed, which is known, is corrected for minor changes based on a calculation using the position signal from the second sensor at 706. With the true strand speed known, the controller effects a finer control of the acceleration of the shear guide to achieve the strand speed at 708. The controller may use a closed-loop control of the acceleration of the shear guide at 710 based on feedback from the encoder on the motor. When the shear guide is determined to be traveling at the strand speed, a first node of an AND logic function 712 is activated, and a first condition is satisfied.

In parallel, the controller begins calculating the true position of the leading edge of the strand based on its position at 714 by use of a position feedback signal from the second sensor at 716. Once the leading edge is determined to be sufficiently close to the stop at 718, a second node of the AND logic function 712 is activated and a second condition is satisfied. With the first condition (speed of the shear guide matching strand speed) and the second condition (length of strand is appropriate) having been both satisfied, the AND function 712 becomes activated and the controller commands a cutter to cut the strand at 720. After the strand has been cut, the controller commands the system to return to a home position or reset at 722 in preparation of the subsequent cut operation.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context, The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for cutting segments of wire from an advancing wire strand, the segments having a predetermined length, the strand traveling at a feed speed into a machine including a cutter, the method comprising:
causing the cutter to accelerate to the feed speed of the strand in a direction along the strand;
determining a length of the strand extending past the cutter based on a signal from a proximity sensor; and
commanding the cutter to cut the strand when the speed of the cutter closely matches the feed speed and when the length of the strand extending past the cutter is determined to be equal to the predetermined length.

2. The method of claim 1, further comprising calculating the feed speed of the strand in an electronic controller based on the signal from the proximity sensor.

3. The method of claim 1, wherein the proximity sensor is disposed to measure a proximity of a moving object, motion of the object being associated with motion of a leading edge of the advancing strand, wherein the object moves at the feed speed when pushed by the leading edge.

4. The method of claim 3, wherein the moving object is a shuttle rod disposed in a housing connected to a frame of the machine.

5. The method of claim 1, further comprising sensing an initiation of motion based on a signal from an additional proximity sensor, the additional proximity sensor disposed to measure proximity of an object that is stationary when the object is not associated with a leading edge of the advancing strand and that moves when the leading edge of the advancing strand contacts the object causing it to move at the feed speed.

6. The method of claim 1, wherein causing the cutter to accelerate is accomplished by engaging a motor arranged to move the cutter, wherein the method further comprises sending a position signal relative to a position of the cutter to an electronic controller, the position signal generated by an encoder associated with the motor.

7. The method of claim 1, wherein the proximity sensor is arranged to measure a distance between a sensing portion of the proximity sensor and an advancing tapered surface, the tapered surface arranged to move at the feed speed.

8. A method for selectively cutting segments of wire from an advancing strand of wire stock material, the segments having a predetermined length, the method comprising:
advancing the strand continuously into a wire cutting machine, the strand advanced at a strand speed, which is maintained constant;
admitting a leading edge of the strand through a shearing assembly, the shearing assembly being movable in the direction of the advancing strand;
pushing a shuttle at the strand speed by allowing the leading edge of the strand to contact a rod connected to a shuttle, the shuttle defining a first feature and a second feature;
sensing proximity of the first feature with a first sensor and relaying a first signal to an electronic controller;
accelerating the shearing assembly to strand speed;
sensing proximity of the second feature with a second sensor to yield a second signal, the proximity of the second feature indicative of a length of the advancing strand extending past the shearing assembly;
relaying the second signal to an electronic controller; and
cutting the strand with the shearing assembly when the shearing assembly is traveling at the strand speed and when the length of the advancing strand extending past the shearing assembly is within a predetermined range.

9. The method of claim 8, further comprising calculating the strand speed in the electronic controller based on the second signal.

10. The method of claim 8, wherein at least one of the first sensor and the second sensor is disposed to measure a proximity of a moving object, motion of the object being associated with motion of a leading edge of the advancing strand, wherein the object moves at the strand speed when pushed by the leading edge.

11. The method of claim 10, wherein the moving object is a shuttle rod disposed in a housing connected to a frame of the wire cutting machine.

12. The method of claim 8, further comprising sensing an initiation of motion based on first signal, the first sensor disposed to measure proximity of an object that is stationary when the object is not associated with a leading edge of the advancing strand and that moves when the leading edge of the advancing strand contacts the object causing it to move at the strand speed.

13. The method of claim 8, wherein accelerating the shearing assembly to strand speed is accomplished by engaging a motor arranged to move the shearing assembly, wherein the method further comprises sending a position signal relative to a position of the cutter to the electronic controller, the position signal generated by an encoder associated with the motor.

14. The method of claim 1, wherein the second sensor is arranged to measure a distance between a sensing portion of the second sensor and an advancing tapered surface, the tapered surface arranged to move at the strand speed.

15. A wire cutting machine adapted to cut segments of wire from a strand of wire, the wire cutting machine controlled by an electronic controller, the wire cutting machine comprising:
a feed portion adapted to advance the strand into the machine;
a shear guide slideably disposed on a rail and selectively moveable by a motor, the rail connected to a frame of the machine, the shear guide defining a strand opening adapted to receive the advancing strand therethrough;
a housing forming a bore extending therethrough, the housing adjustably connected to a support member, the support member connected to the frame of the machine, the housing defining first and second sensor openings, the first and second sensor openings extending radially through the housing and communicating with the bore;
a shuttle rod disposed in the bore of the housing, the shuttle rod defining an internal bore and an external tapered portion, the tapered portion terminating at a step;
a gage rod at least partially disposed in the internal bore of the shuttle rod, the gage rod connected to the shuttle rod, the gage rod adapted to contact a leading edge of the advancing strand such that the gage rod and shuttle rod are adapted to move at the strand speed with respect to the housing;
a first sensor disposed in the first sensor opening of the housing, the first sensor disposed to sense proximity of the step;
a second sensor disposed in the second sensor opening of the housing, the second sensor disposed to sense distance between the second sensor and a location on the tapered portion;
an electronic controller operably connected to the motor and to the first and second sensors, the electronic controller operating to:
receive a first signal from the first sensor when the step advances past the first sensor opening;
accelerate the shear guide such that the shear guide travels at the speed of the advancing strand;
calculate a distance traveled by the shuttle rod based on a second signal from the second sensor; and
actuate a cutter to cut the advancing strand when the shear guide is determined to be traveling at the speed of the advancing strand and when the distance traveled by the shuttle rod is equal to a predetermined distance.

16. The wire cutting machine of claim 1, further comprising a position encoder operably associated with the motor, the encoder arranged to relay a position of the shear guide to the electronic controller for use when accelerating the shear guide to the speed of the advancing strand.

17. The wire cutting machine of claim 1, further comprising an actuator associated with the cutter, wherein the cutter operates to cut the strand against the shear guide.

18. The wire cutting machine of claim 1, wherein the first sensor operates as a switch, and wherein the second sensor is an analog output proximity sensor.

19. The wire cutting machine of claim 1, further comprising a user interface operably associated with the electronic controller, the user interface capable of inputting programming information into the electronic controller and capable of presenting information relative to the operation of the wire cutting machine to a user.

20. The wire cutting machine of claim 1, further comprising a rotating arbor operating to straighten the advancing strand, the rotating arbor included in the feed portion.
